(19) United States
(12) Patent Application Publication
(10) Pub. No.: US 2026/0044916 A1
(43) Pub. Date: Feb. 12, 2026

(54) DEVICE AND METHOD FOR TEACHING MATERIALS ANALYSIS USING AUTO-ENCODER

(71) Applicant: Firsthabit Co.,Ltd., Seoul (KR)

(72) Inventor: Jung Woo KANG, Seoul (KR)

(73) Assignee: Firsthabit Co.,Ltd., Seoul (KR)

(21) Appl. No.: 19/295,168

(22) Filed: Aug. 8, 2025

(30) Foreign Application Priority Data
Aug. 12, 2024 (KR) 10-2024-0107538

(51) Int. Cl. G06Q 50/20; G06N 3/0455; G09B 7/04

(52) U.S. Cl. CPC G06Q 50/205; G06N 3/0455; G09B 7/04

(57) ABSTRACT

A device and method for analyzing teaching materials using an auto-encoder is provided. The teaching material analysis device includes a data collection module configured to receive teaching material data including question data related to a predefined question, solution data for the corresponding answer, and submission data representing a user's problem-solving process. An analysis module generates analysis data based on at least one of the question data and the submission data, using the received teaching material data and submission data. The analysis module identifies requirement information by comparing question data and solution data, and determines deficiency information by analyzing differences between solution data and submission data using a pre-trained auto-encoder. An output module then outputs the analysis data as output data. The device enables accurate identification of concepts required to solve questions and concepts lacking in user responses, facilitating adaptive educational feedback through AI-driven conceptual analysis.

### CROSS-REFERENCE TO RELATED APPLICATION

This application claims priority under 35 U.S.C. § 119 to Korean Patent Application No. 10-2024-0107538 filed on Aug. 12, 2024, in the Korean Intellectual Property Office, the entire contents of which are hereby incorporated by reference.

### BACKGROUND

### Technical Field

The disclosure relates to a device and a method for analyzing teaching materials using an auto-encoder, which is a type of neural network based on artificial intelligence (AI) technology.

More particularly, the disclosure relates to a device and a method for analyzing teaching materials that can analyze concepts necessary for solving questions by analyzing the corresponding questions and solutions contained in a teaching material using a neural network, and furthermore, can identify the capability of a learner and, at the same time, present concepts requiring additional learning to the corresponding learner by comparing and analyzing the solution and the learner's submission using an auto-encoder.

### Description of the Related Art

The content set forth in this section merely provides background information on the present embodiments and does not constitute prior art.

Learners study specific subjects, concepts, etc., by using teaching materials (e.g., textbooks, workbooks, exercise books, etc.) as well as lectures given by teachers, and there are a great variety and number of teaching materials produced and sold on the market for each subject and concept.

However, in the case of teaching materials that are currently sold and distributed, questions are merely distinguished by unit, and there is no explanation of what concepts are specifically required to solve corresponding questions.

That is, although learners often need to know multiple concepts that are connected organically to each other in advance in order to solve a single question, typical teaching materials often do not account for or specify such points, and instead simply classify multiple questions into corresponding units.

To further elaborate, existing teaching material systems are limited in their ability to computationally understand the semantic and conceptual structure of question-solution pairs or to analyze a learner's submission with sufficient granularity. These systems often rely on rule-based classification or superficial pattern matching, which lack adaptability, precision, and scalability. There is a need for a computer-implemented system that can perform fine-grained concept analysis of educational content and user submissions using advanced artificial intelligence models, enabling more accurate and individualized feedback based on machine-interpretable conceptual mappings.

Accordingly, it may be necessary to analyze what multiple organically connected concepts are to solve a particular question, and what concepts a learner lacked, which has caused the learner to fail to solve the corresponding question, if the learner has presented a wrong answer.

Further, with the recent advancements in AI technology, there are various attempts and needs to utilize AI technology in the field of education.

The present disclosure relates to improvements in automated educational analysis systems, and more specifically to machine learning methods for semantic processing of educational content and student submissions. Conventional systems cannot process unstructured text or handwritten inputs to reliably infer underlying conceptual understanding. This disclosure addresses the technical challenge of enabling a computing system to interpret, compare, and diagnose concept-level knowledge using latent representations, embedding vectors, and neural encoding structures.

### BRIEF SUMMARY

The disclosed system analyzes educational content and learner performance to determine both the concepts necessary to solve specific questions and the concepts a learner may be lacking. It uses pretrained embedding models such as BERT or Word2Vec to convert question data, solution data, and curriculum-based concept information into embedding vectors. These vectors are compared to identify which concepts are required to answer a question, enabling an automated, data-driven approach to analyzing learning content without relying on manual classification.

The system also utilizes a pretrained autoencoder to compare the latent representations of a model solution and a learner's submission. By detecting features present in the solution but absent in the learner's response, the system identifies specific conceptual gaps. These gaps are then mapped back to predefined curricular concepts, allowing for tailored feedback that reflects the learner's actual understanding and aligns with structured learning objectives.

The combination of embedding-based concept mapping, autoencoder-based deficiency detection, and curriculum-aware analysis offers a technical solution to the problem of linking unstructured learner input with structured educational goals. This approach improves the technical process of instructional assessment and learner diagnostics.

Various embodiments of the present disclosure provide a device and a method for analyzing teaching materials that can quickly and accurately identify what concepts are necessary to solve a question by analyzing the questions and solutions contained in a teaching material using a neural network based on AI technology.

Various embodiments of the present disclosure provide a device and a method for analyzing teaching materials that can identify the capability of a learner and, at the same time, provide the corresponding learner with what concepts require additional learning, i.e., what concepts the learner lacks by identifying the concepts necessary to solve a question by analyzing the questions and solutions contained in a teaching material and then comparing and analyzing the solution and the learner's submission using an auto-encoder, which is a type of neural network.

Further, the disclosed system provides a computer-implemented method and device that improve the analysis of teaching materials and learner performance by applying trained machine learning models. The system employs pretrained embedding techniques to convert unstructured educational data into vector representations in embedding space, enabling semantic comparisons between questions, solutions, and curriculum-aligned concepts. Additionally, a pretrained autoencoder encodes both the reference solution and the learner's response into latent representations, allowing for the automated identification of conceptual gaps. These processes improve the technical capability of a computing system to perform accurate, scalable, and adaptive educational assessments.

The technical benefits of the present disclosure are not limited to those mentioned above, and other benefits and advantages of the present disclosure that have not been mentioned can be understood by the following description and will be more clearly understood by the embodiments of the present disclosure. Furthermore, it will be readily appreciated that the objects and advantages of the present disclosure can be realized by the means set forth in the claims and combinations thereof.

According to some aspects of the disclosure, a teaching material analysis device comprises a data collection module configured to receive teaching material data including question data related to a predefined question and solution data related to an answer to the question, and submission data related to problem-solving of a user for the question; an analysis module configured to generate analysis data for at least one of the question data and the submission data based on the teaching material data and the submission data; and an output module configured to output the analysis data as output data, wherein the analysis module comprises: a question analysis unit configured to define requirement information related to concepts required to solve the question by comparing the question data with the solution data; a submission analysis unit configured to determine some of the generated requirement information as deficiency information related to concepts the user lacks by comparing the solution data with the submission data; and a determination unit configured to determine at least one of the requirement information and the deficiency information as the analysis data.

Further, the data collection module further receives concept information comprising a concept set and a concept tree, which are predefined, from a curriculum database that is present externally.

Further, the question analysis unit determines at least one concept included in the concept information as the requirement information by comparing the question data with the solution data.

Further, the question analysis unit comprises: an embedding unit configured to generate a question embedding vector, a solution embedding vector, and a concept embedding vector by converting the question data, the solution data, and the concept information into embedding vectors; and a first comparison unit configured to define the requirement information based on the question embedding vector, the solution embedding vector, and the concept embedding vector.

Further, the embedding unit generates the question embedding vector, the solution embedding vector, and the concept embedding vector by using a pre-trained embedding vector conversion algorithm.

Further, the first comparison unit: determines an overlapping vector that overlaps with the question embedding vector and the solution embedding vector out of the concept embedding vector, and determines a concept corresponding to the overlapping vector out of the plurality of concepts as the requirement information.

Further, the submission analysis unit generates the deficiency information by comparing the solution data with the submission data using a pre-trained auto-encoder.

Further, the submission analysis unit includes: an encoder unit configured to generate a solution encoding and a submission encoding by encoding each of the solution data and the submission data in the form of a latent representation; and a second comparison unit configured to determine the deficiency information based on the solution encoding and the submission encoding.

Further, the second comparison unit: determines a missing vector that is included in the solution encoding but not in the submission encoding by comparing the solution encoding with the submission encoding, and determines a concept corresponding to the determined missing vector out of a plurality of concepts included in the requirement information as the deficiency information.

Further, the teaching material analysis device further comprises: a training module configured to train an embedding unit and a first comparison unit included in the question analysis unit, and an encoder unit and a second comparison unit included in the submission analysis unit.

The device and the method for analyzing teaching materials according to some embodiments of the present disclosure can quickly and accurately identify what concepts are necessary to solve a question by analyzing the questions and solutions contained in a teaching material using a neural network based on AI technology. That is, the device and the method for analyzing teaching materials according to some embodiments of the present disclosure have a novel effect of being able to identify what concepts a learner must be familiar with in order to reach a solution from a question by comparing and analyzing the questions and solutions contained in a teaching material using a neural network.

In addition, the device and the method for analyzing teaching materials according to some embodiments of the present disclosure have a novel effect of being able to identify the capability of a learner and, at the same time, provide the corresponding learner with what concepts require additional learning, i.e., what concepts the learner lacks by comparing and analyzing a solution and the learner's submission using an auto-encoder, which is a type of neural network. That is, the device and the method for analyzing teaching materials according to some embodiments of the present disclosure can determine which concepts a learner lacks out of the concepts necessary to reach a solution from a question by comparing and analyzing the solution and the learner's submission.

As noted above, the disclosed system provides a computer-implemented method and device that improve the analysis of teaching materials and learner performance by applying trained machine learning models. The system employs pretrained embedding techniques to convert unstructured educational data into vector representations in embedding space, enabling semantic comparisons between questions, solutions, and curriculum-aligned concepts. Additionally, a pretrained autoencoder encodes both the reference solution and the learner's response into latent representations, allowing for the automated identification of conceptual gaps. These processes improve the technical capability of a computing system to perform accurate, scalable, and adaptive educational assessments beyond the capabilities of conventional rule-based systems.

In addition to the foregoing description, specific effects of the present disclosure will be described together while describing specific details for practicing the present disclosure below.

### BRIEF DESCRIPTION OF THE SEVERAL VIEWS OF THE DRAWINGS

FIG. 1 shows a teaching material analysis system according to some embodiments of the present disclosure.

FIG. 2 is a block diagram of the teaching material analysis device according to some embodiments of the present disclosure.

FIG. 3 shows one example of question data and solution data included in the teaching material data according to some embodiments of the present disclosure.

FIG. 4 shows one example of the submission data according to some embodiments of the present disclosure.

FIG. 5 shows one example of the concept information according to some embodiments of the present disclosure.

FIG. 6 is a diagram for describing the structure of the neural network according to some embodiments of the present disclosure.

FIG. 7 is a block diagram of the analysis module according to some embodiments of the present disclosure.

FIG. 8a is a detailed block diagram of the question analysis unit included in the analysis module according to some embodiments of the present disclosure.

FIG. 8b is a diagram for describing the operation of the question analysis unit according to some embodiments of the present disclosure.

FIG. 9a is a detailed block diagram of the submission analysis unit included in the analysis module according to some embodiments of the present disclosure.

FIG. 9b is a diagram for describing an auto-encoder according to some embodiments of the present disclosure.

FIG. 9c is a diagram for describing the operation of the submission analysis unit according to some embodiments of the present disclosure.

FIG. 10 is a flowchart of a teaching material analysis method according to some embodiments of the present disclosure.

FIG. 11 is a diagram for describing a hardware implementation of a teaching material analysis device that performs a teaching material analysis method according to some embodiments of the present disclosure.

### DETAILED DESCRIPTION

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc., used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc., should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

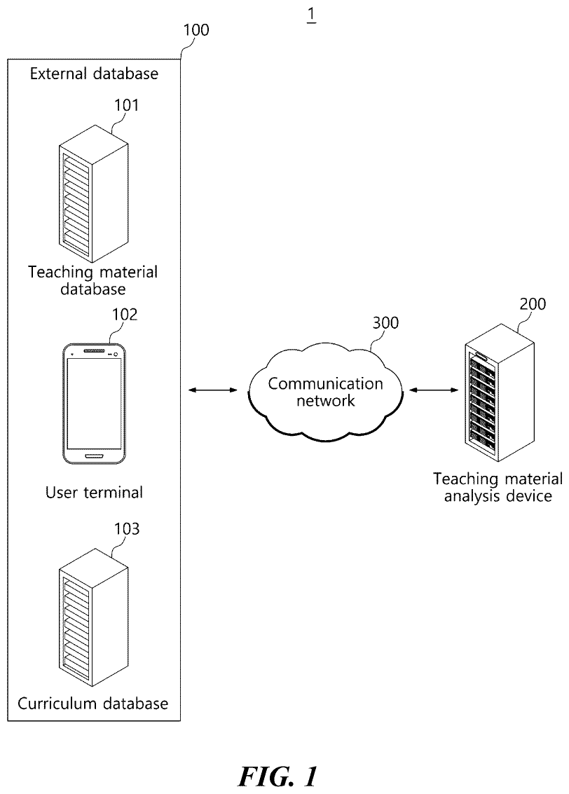

Hereinafter, a device and a method for analyzing teaching materials and a teaching material analysis system including the same according to some embodiments of the present disclosure will be described with reference to FIGS. 1 to 11.

FIG. 1 shows a teaching material analysis system according to some embodiments of the present disclosure.

Traditional educational systems lack the capacity to extract high-level semantic relationships between student responses and curricular concepts in an automated manner. The disclosed teaching material analysis system improves upon such systems by enabling the machine to encode, compare, and analyze latent representations of question-solution pairs and student submissions, thereby offering more accurate and scalable concept-based feedback. These improvements are made possible through the integration of pretrained deep learning models, which are not present in routine or generic educational software.

Referring to FIG. 1, a teaching material analysis system 1 may include an external database 100, a teaching material analysis device 200, and a communication network 300.

The external database 100 is a database that transmits input data for question analysis and submission analysis to the teaching material analysis device 200.

As some examples, the external database 100 may include a teaching material database 101, a user terminal 102, and a curriculum database 103. However, the embodiment of the present disclosure is not limited thereto, and it is obvious that some of the teaching material database 101, the user terminal 102, and the curriculum database 103 included in the external database 100 may be implemented in integration, or the external database 100 may include more types of objects.

The teaching material database 101 is a database that stores, manages, analyzes, and saves teaching material data. The teaching material database 101 may transmit the teaching material data to the user terminal 102, the teaching material analysis device 200, and the like. In this case, the teaching material data may include question data on predefined questions and solution data on the answers to the questions. However, the embodiment of the present disclosure is not limited thereto. Further, the teaching material database 101 may be in the form of a workstation, a data center, an internet data center (IDC), a direct attached storage (DAS) system, a storage area network (SAN) system, a network attached storage (NAS) system, and a redundant array of inexpensive disks or a redundant array of independent disks (RAID) system, but the embodiment of the present disclosure is not limited thereto.

The user terminal 102 is a device that generates, manages, and transmits submission data related to user responses to question data included in the teaching material data and to solving questions. The user terminal 102 may transfer this submission data to the teaching material analysis device 200. In this case, the user terminal 102 may output the question data received via the teaching material database 101 onto a screen, and generate submission data through a touch input, keyboard input, or the like by the user in response thereto. Further, the user terminal 102 may be in the form of various types of electronic devices such as a smartphone, a computer, a laptop PC, a wearable device, an IoT device, etc., but the embodiment of the present disclosure is not limited thereto.

The curriculum database 103 is a database that stores, manages, and transmits information on subjects, curricula, and the like. As one example, the curriculum database 103 may store concept information on predefined subjects, etc. In this case, the concept information may include a concept set containing a plurality of predefined concepts and/or a concept tree in which a plurality of concepts is ordered according to a predefined learning sequence and concept difficulty, but the embodiment of the present disclosure is not limited thereto. The curriculum database 103 may transfer this concept information to the teaching material analysis device 200. Further, the curriculum database 103 may be in the form of a workstation, a data center, an internet data center (IDC), a direct attached storage (DAS) system, a storage area network (SAN) system, a network attached storage (NAS) system, and a redundant array of inexpensive disks or a redundant array of independent disks (RAID) system, but the embodiment of the present disclosure is not limited thereto.

The teaching material analysis device 200 may generate analysis data related to question analysis and teaching material analysis based on the input data received from the external database 100, and output the generated analysis data as output data.

As one example, the teaching material analysis device 200 may compare the question data with the solution data by using a neural network, and define and identify requirement information, which is a concept required to solve a question.

As another example, the teaching material analysis device 200 may compare the solution data with the submission data by using an auto-encoder, and identify concepts that the user lacks (deficiency information) out of the concepts required to solve the question.

The specific process by which the teaching material analysis device 200 identifies the requirement information and the deficiency information will be described later.

The communication network 300 refers to a communication means that performs data exchange between the external database 100 and the teaching material analysis device 200.

In this case, the communication network 300 may include a network based on wired Internet technology, wireless Internet technology, and short-range communication technology. The wired Internet technology may include, for example, at least one of a local area network (LAN) and a wide area network (WAN). The wireless Internet technology may include, for example, at least one of wireless LAN (WLAN), Digital Living Network Alliance (DMNA), Wireless Broadband (WiBro), World Interoperability for Microwave Access (WiMAX), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), and 5G New Radio (NR) technology. However, the present embodiment is not limited thereto. The short-range communication technology may include, for example, at least one of Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, Wi-Fi Direct, and 5G New Radio (NR). However, the present embodiment is not limited thereto.

The teaching material analysis system 1 shown in FIG. 1 improves the technical functioning of automated educational platforms by enabling fine-grained semantic analysis of unstructured textual and visual data, leveraging pretrained neural models to perform concept identification and comparison without manual labeling, and delivering real-time, curriculum-aligned feedback based on conceptual vector analysis of learner submissions.

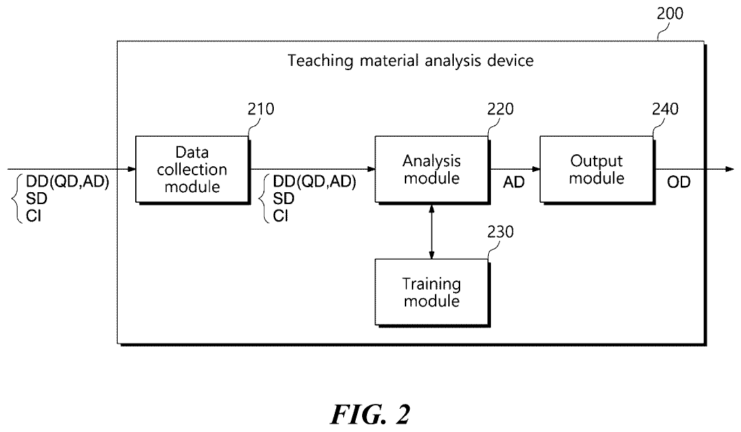

In the following, the structure and operation of the teaching material analysis device 200 according to some embodiments of the present disclosure will be described in greater detail with reference to FIGS. 2 to 11.

FIG. 2 is a block diagram of the teaching material analysis device according to some embodiments of the present disclosure.

Referring to FIGS. 1 and 2, the teaching material analysis device 200 may include a data collection module 210, an analysis module 220, a training module 230, and an output module 240.

The data collection module 210 may receive input data from the external database 100. In this case, the input data may include teaching material data (hereinafter referred to as “DD”), submission data (hereinafter referred to as “SD”), and concept information (hereinafter referred to as “CI”). In other words, the data collection module 210 may receive the teaching material data DD, the submission data SD, and the concept information CI from the external database 100.

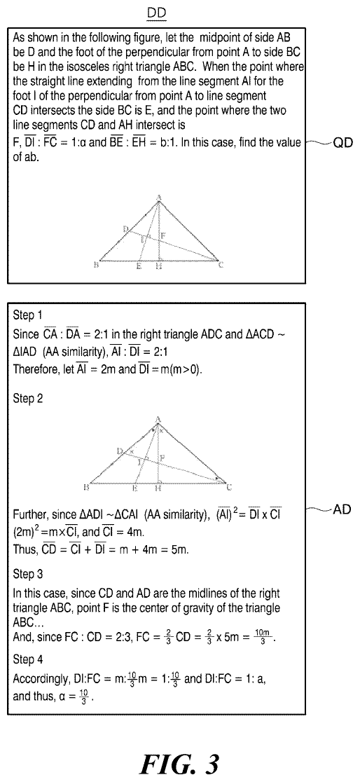

In the following, the teaching material data DD, the submission data SD, and the concept information CI according to some embodiments of the present disclosure will be described in detail with reference to FIGS. 3 to 5.

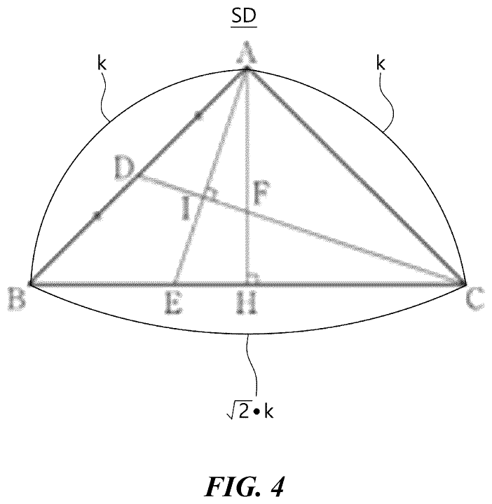

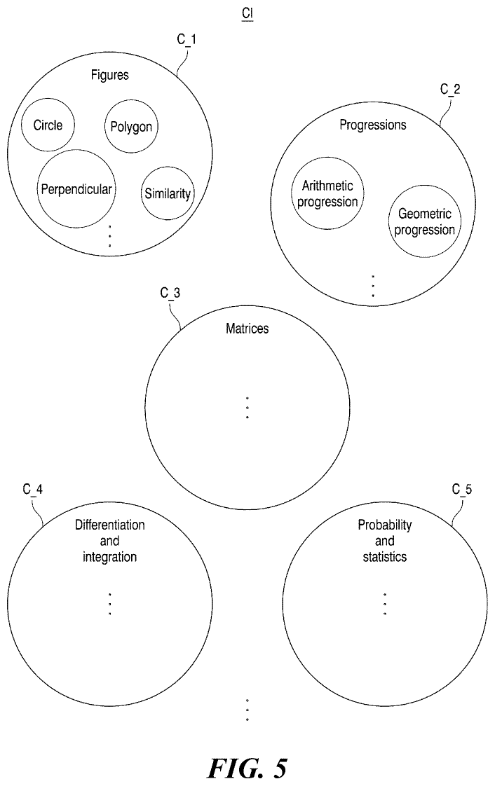

FIG. 3 shows one example of question data and solution data included in the teaching material data according to some embodiments of the present disclosure. FIG. 4 shows one example of the submission data according to some embodiments of the present disclosure. FIG. 5 shows one example of the concept information according to some embodiments of the present disclosure.

Referring to FIG. 3, the teaching material data DD may refer to data on questions and solutions present in a teaching material.

As some examples, the teaching material data DD may include question data (hereinafter referred to as “QD”) for predefined questions and solution data (hereinafter referred to as “AD”) related to answers to the corresponding questions. However, the embodiment of the present disclosure is not limited thereto.

The question data QD may refer to data on each of a plurality of questions included in the teaching material. In this case, the question data QD may include text data, image data, and the like, as shown in FIG. 3, but the embodiment of the present disclosure is not limited thereto.

The solution data AD may be data on the answer to each of the plurality of questions included in the teaching material. In this case, the solution data AD may include information on the answer to a corresponding question, the processes for deriving the answer, and the like. In this case, the solution data AD may include text data, image data, and the like, as shown in FIG. 3, but the embodiment of the present disclosure is not limited thereto.

Referring to FIG. 4, the submission data SD is data on the user's response to the corresponding question, the process of solving the question, the result of solving the question, and the like.

As some examples, the user terminal 102 may output the question data QD received via the teaching material database 101 onto a screen, receive the user's touch input, keyboard input, or the like in response thereto, and then generate submission data SD of the user based on the received data.

FIG. 4 shows, as one example, submission data SD generated based on the response of the user, where the user has set the length of one side of the triangle to “k” and has set the length of the hypotenuse to “√2k” according to the property of an isosceles right triangle in the process of deriving the answer. Here, in the case of FIG. 4, the submission data SD does not show data related to the answer in the question data QD, and accordingly, it can be interpreted that the user was unable to derive the answer to the corresponding question.

Referring to FIG. 5, the concept information CI may include a plurality of concepts contained in textbooks, curricula, etc. In this case, the concept information CI may include a plurality of concepts distinguished by predefined types. As one example, the concept information may include a concept set containing a plurality of predefined concepts and/or a concept tree in which a plurality of concepts is ordered according to a predefined learning sequence and concept difficulty.

FIG. 5 shows, for convenience of description, that the concept information CI includes a first concept C_1 to a fifth concept C_5 related to the subject of “mathematics,” the first concept C_1 is a concept related to “figures,” the second concept C_2 is a concept related to “progressions,” the third concept C_3 is a concept related to “matrices,” the fourth concept C_4 is a concept related to “differentiation and integration,” and the fifth concept C_5 is a concept related to “probability and statistics.” In this case, each concept C_1 to C_5 may include sub-concepts belonging to the corresponding concept, as shown in FIG. 5. For example, the first concept C_1 related to “figures” may include concepts of “circle, polygon, perpendicular, similarity of figures, and the like” and the second concept C_2 related to “progressions” may include concepts of “arithmetic progression, geometric progression, and the like.”

Referring again to FIGS. 1 and 2, the data collection module 210 may transfer the teaching material data DD, the submission data SD, and the concept information CI to other components in the teaching material analysis device 200. As one example, the data collection module 210 may transfer the teaching material data DD, the submission data SD, and the concept information CI to the analysis module 220 or the like, but the embodiment of the present disclosure is not limited thereto.

The analysis module 220 may generate analysis data (hereinafter referred to as “AAD”) based on the teaching material data DD, the submission data SD, and the concept information CI. In this case, the analysis data AAD may include requirement information, which is a concept required to solve the question data QD, and deficiency information, which is a concept that the user lacks out of the corresponding requirement information. A detailed description thereof will be given later.

Further, the analysis module 220 may generate the analysis data AAD from the teaching material data DD, the submission data SD, and the concept information CI by using AI (artificial intelligence) technology. In this case, the analysis module 220 may generate the analysis data AAD from the teaching material data DD, the submission data SD, and the concept information CI by using deep learning methods and structures. As one example, the analysis module 220 may generate the analysis data AAD by using a pre-trained neural network structure.

In a more detailed description, a deep-learning technique, which is a kind of machine learning, goes down to a deep level and learns in multiple stages based on data. In other words, deep learning refers to a set of machine learning algorithms that extract core data from a plurality of data while moving up the stages.

As some examples, the neural network may use a variety of known deep learning structures. For example, the neural network may use structures such as a convolutional neural network (CNN), a recurrent neural network (RNN), a deep belief network (DBN), a graph neural network (GNN), a generative adversarial network (GAN), a transformer, and an auto-encoder.

Specifically, a CNN (convolutional neural network) is a model that simulates the function of the human brain, created based on the assumption that when a person recognizes an object, s/he extracts basic features of the object, then performs complex calculations in the brain, and based on the results, recognizes the object. The CNN may include, but is not limited to, known structures such as LeNet, AlexNet, VGGNet, GoogleNet, and ResNet.

An RNN (recurrent neural network) is widely used for natural language processing, etc., is a structure effective in processing time-series data that changes over time, and is capable of constructing an artificial neural network structure by stacking layers at every instant.

A DBN (deep belief network) is a deep learning structure constructed by stacking a restricted Boltzmann machine (RBM), which is a deep learning technique, in multiple layers. When a certain number of layers are obtained by repeating restricted Boltzmann machine (RBM) training, a DBN (deep belief network) having the corresponding number of layers can be constructed.

A GNN (graphic neural network, hereinafter, GNN) refers to an artificial neural network structure implemented in a way that derives a similarity and feature points between modeling data by using the modeling data modeled based on data mapped between particular parameters.

A GAN (generative adversarial network, hereinafter, GAN) refers to an artificial neural network structure that creates new data in a similar form to the input data by using a generative neural network and a discriminative neural network. The GAN may include the known DCGAN (deep convolutional GAN), CGAN (conditional GAN), WGAN (Wasserstein GAN), StyleGAN (style-based GAN), CycleGAN, etc., but the embodiment of the present disclosure is not limited thereto.

A transformer is an artificial neural network in an encoder-decoder structure that utilizes attention, and allows for identifying the overall meaning between an input sequence and an output sequence. Transformers allow all elements of an input sequence to affect an output sequence by using an attention mechanism, and through this, both the encoder and decoder can take the entire sequence into account. Transformers can use not only natural languages and time series data but also images as input by patching them.

An auto-encoder is a deep learning structure that performs the role of extracting and reconstructing the features of data. Representatively, an auto-encoder includes an encoder that compresses input values and a decoder that reconstructs the compressed data. The encoder converts input values into lower-dimensional latent representations, and the decoder reconstructs the latent representations in the same dimension as the input values. In this case, the encoder and decoder may each be composed of a multilayer perceptron (MLP). When training an auto-encoder, input data is input, and weights and biases are used in the training in a direction of minimizing the difference between the output value and the input value. The auto-encoder trained as such can extract the features of input data well and reconstruct noisy input data. Auto-encoders are utilized mainly in the fields of data compression, dimensionality reduction, noise removal, data generation, etc., and can also be utilized in the fields of image recognition, natural language processing, speech recognition, etc.

Further, the training of the artificial neural network of the neural network may be achieved by adjusting the weights of the connecting lines between nodes (and also adjusting the bias values if necessary) so that a desired output is obtained for a given input. In addition, the artificial neural network can continuously update the weight values by training. Moreover, methods such as backpropagation may be used for training the artificial neural network.

In this case, unsupervised learning, semi-supervised learning, supervised learning, and the like may be used as the machine learning method of the artificial neural network. Furthermore, the neural network may be controlled to automatically update the artificial neural network structure for outputting analysis data after training according to settings.

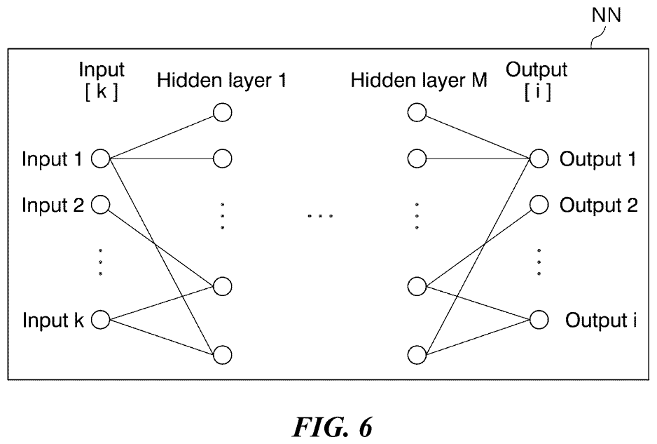

In the following, a neural network structure according to some embodiments of the present disclosure will be described with reference to FIG. 6.

FIG. 6 is a diagram for describing the structure of the neural network according to some embodiments of the present disclosure.

Referring to FIG. 6, the neural network (hereinafter referred to as “NN”) according to some embodiments of the present disclosure may include an input layer Input, an output layer Output, and M hidden layers arranged between the input layer and the output layer.

Here, weights may be set for the edges that connect the nodes in the respective layers. The presence or absence of such weights or edges may be added, removed, or updated during the training process. Therefore, the weights of the nodes and edges arranged between k input nodes and i output nodes may be updated through the training process.

Before the neural network NN performs training, all nodes and edges may be set to initial values. However, if information is input cumulatively, the weights of the nodes and edges may be changed, and in this process, matching may be made between the parameters input as training factors and the values assigned to output nodes.

Additionally, if a cloud server is utilized, the neural network NN may receive and process a large number of parameters. Therefore, the neural network NN may perform training based on an immense amount of data.

The weights of the nodes and edges between the input and output nodes constituting the neural network NN may be updated by the training process of the neural network NN. Furthermore, the parameters input to or output from the neural network NN may be further expanded to various data.

Referring again to FIGS. 1 and 2, the analysis module 220 may be trained by the training module 230.

As some examples, the training module 230 may control the training of the analysis module 220 and the neural network included in the analysis module 220. In other words, the training module 230 may proceed with and control the training process of the analysis module 220 by using predefined training data. In this case, the training module 230 may provide a control signal for controlling the training of the analysis module 220, labeling data used in the training process of the analysis module 220, etc., to the analysis module 220. As one example, the training module 230 may train an embedding unit, a first comparison unit, an encoder unit, and a second comparison unit included in the analysis module 220, and/or algorithms used by each component, or the like.

The output module 240 may generate and output output data (hereinafter referred to as “OD”) based on the analysis data AAD.

As one example, the analysis data AAD may include requirement information, deficiency information, and the like as described later, and in this case, the output module 240 may generate and output a graphic object in which the requirement information, the deficiency information, and the like are visually comprehensively displayed as output data OD. In this case, the output data OD may be in the form of a text graphic object, an image graphic object, a video graphic object, etc.

Further, when the output data OD based on the analysis data AAD is generated, the output module 240 may output the generated output data OD to the user terminal 102 included in the external database 100 or the like.

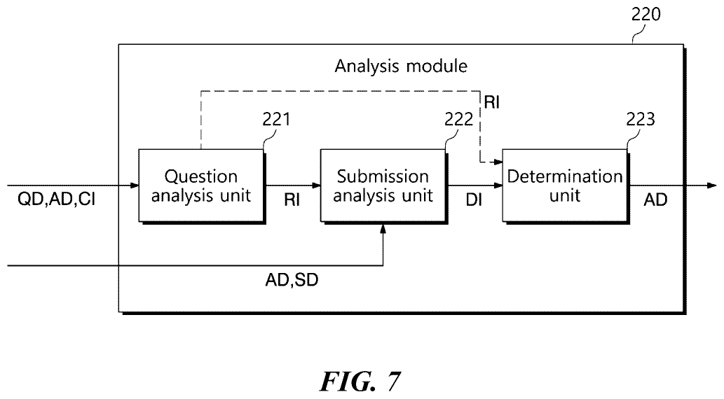

In the following, the operation of the analysis module 220 according to some embodiments of the present disclosure will be described in greater detail with reference to FIGS. 7 to 9c.

FIG. 7 is a block diagram of the analysis module according to some embodiments of the present disclosure.

Referring to FIGS. 2 and 7, the analysis module 220 according to some embodiments of the present disclosure may include a question analysis unit 221, a submission analysis unit 222, and a determination unit 223.

The question analysis unit 221 may define requirement information (hereinafter referred to as “RI”) based on the question data QD, the solution data AD, and the concept information CI.

As some examples, the question analysis unit 221 may determine at least one concept included in the concept information CI as the requirement information RI by comparing the question data QD with the solution data AD. For example, the question analysis unit 221 may determine at least one concept of a plurality of concepts (e.g., C_1 to C_5 in FIG. 5) included in the concept information CI and sub-concepts included therein as the requirement information RI based on the comparison result of the question data QD with the solution data AD.

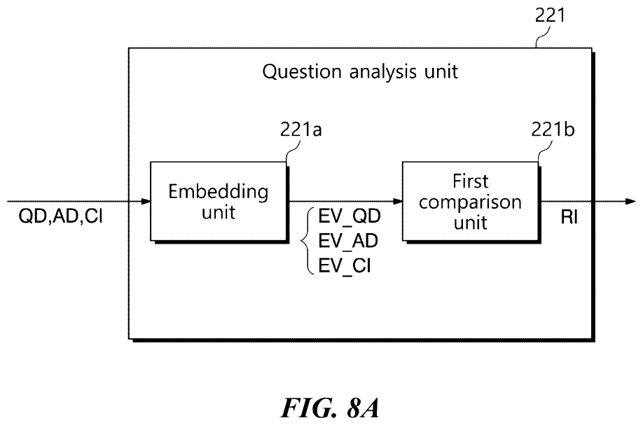

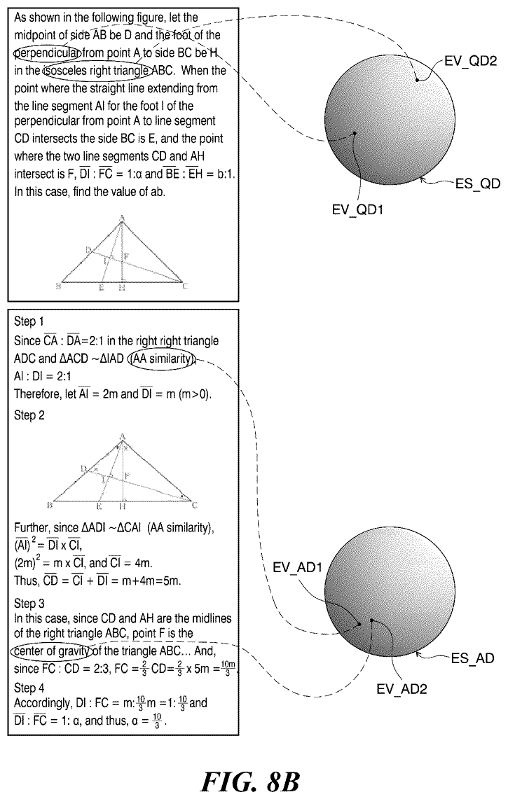

In the following, the question analysis unit 221 according to some embodiments of the present disclosure will be described in greater detail with reference to FIGS. 8a and 8b.

FIG. 8a is a detailed block diagram of the question analysis unit included in the analysis module according to some embodiments of the present disclosure. FIG. 8b is a diagram for describing the operation of the question analysis unit according to some embodiments of the present disclosure.

Referring to FIGS. 2, 7, 8a, and 8b, the question analysis unit 221 may include an embedding unit 221a that converts each of the question data QD, the solution data AD, and the concept information CI into embedding vectors (hereinafter referred to as “EV”), and a first comparison unit 221b that defines the requirement information RI based on the embedding conversion result.

The embedding unit 221a may convert each of the question data QD, the solution data AD, and the concept information CI into embedding vectors EV, thereby generating a question embedding vector EV_QD, a solution embedding vector EV_AD, and a concept embedding vector EV_CI. In other words, the embedding unit 221a may convert each of the question data QD, the solution data AD, and the concept information CI into embedding vectors EV, thereby generating the question embedding vector EV_QD, the solution embedding vector EV_AD, and the concept embedding vector EV_CI represented in embedding spaces (hereinafter referred to as “ES”).

In this case, each of the question embedding vector EV_QD, the solution embedding vector EV_AD, and the concept embedding vector EV_CI may be in the form of a set of a plurality of sub-vectors.

Describing with FIG. 8b as an example, the embedding unit 221a may convert question data QD into a question embedding vector EV_QD represented in an embedding space ES_QD, and convert solution data AD into a solution embedding vector EV_AD represented in an embedding space ES_AD. Although not shown in FIG. 8b, it is obvious that the embedding unit 221a may convert concept information CI into a concept embedding vector EV_CI in a corresponding embedding space ES.

In this case, FIG. 8b shows for convenience of description that the embedding unit 221a has converted the word “perpendicular” out of the words included in the question data QD into a first question embedding vector EV_QD1, has converted the word “isosceles right triangle” into a second question embedding vector EV_QD2, has converted the word “similarity” out of the words included in the solution data AD into a first solution embedding vector EV_AD1, and has converted the word “center of gravity” into a second solution embedding vector EV_AD2. That is, the embedding unit 221a can extract features in the form of text or images from each of the question data QD, the solution data AD, and the concept information CI, and then generate embedding vectors EV_QD, EV_AD, and EV_CI represented in each embedding space ES based on the extracted features.

Further, the embedding unit 221a may generate the question embedding vector EV_QD, the solution embedding vector EV_AD, and the concept embedding vector EV_CI using a pre-trained embedding vector conversion algorithm. In this case, the embedding vector conversion algorithm is an algorithm that converts text and/or an image into an embedding vector when the corresponding text and/or image is input, and may include Word2Vec, BERT (Bidirectional Encoder Representations from Transformers) model, Siamese Networks, CLIP (Contrastive Language-Image Pre-training) model, or a combination thereof, but the embodiment of the present disclosure is not limited thereto. In this case, the training module 230 can train the embedding unit 221a to output the question embedding vector EV_QD, the solution embedding vector EV_AD, and the concept embedding vector EV_CI as training data based on the question data QD, the solution data AD, and the concept information CI as training data, in the “learning phase” of the embedding unit 221a. In this case, the question embedding vector EV_QD, the solution embedding vector EV_AD, and the concept embedding vector EV_CI as training data may serve as answer data, i.e., labeling data, in the learning process of the embedding unit 221a, and may be data provided for learning progress by the manager of the teaching material analysis device 200.

The first comparison unit 221b may define the requirement information RI based on the embedding conversion result of the embedding unit 221a. In other words, the first comparison unit 221b may determine at least one concept of the plurality of concepts (e.g., C_1 to C_5 in FIG. 5) included in the concept information CI and the sub-concepts included therein as the requirement information RI based on the question embedding vector EV_QD, the solution embedding vector EV_AD, and the concept embedding vector EV_CI.

As some examples, the first comparison unit 221b may determine the requirement information RI based on whether the question embedding vector EV_QD and the solution embedding vector EV_AD overlap with the concept embedding vector EV_CI.

For example, the first comparison unit 221b may determine overlapping vectors that overlap with the question embedding vector EV_QD and the solution embedding vector EV_AD out of the concept embedding vectors EV_CI, and may determine concepts corresponding to the overlapping vectors out of the plurality of concepts (e.g., C_1 to C_5 in FIG. 5) and the sub-concepts included therein as the requirement information RI. In other words, the first comparison unit 221b may determine a first overlapping vector that overlaps between the question embedding vector EV_QD and the concept embedding vector EV_CI, determine a second overlapping vector that overlaps between the solution embedding vector EV_AD and the concept embedding vector EV_CI, and determine a concept corresponding to each of the determined first overlapping vector and second overlapping vector as the requirement information RI.

Unlike traditional systems that rely on static rules or keyword matching, the question analysis unit transforms educational content into high-dimensional vector representations using pretrained language and vision models (such as BERT or CLIP). This transformation enables the system to compute semantic similarity and alignment between concepts in ways that are not possible through deterministic logic or symbol matching. The embedding-based approach reflects a fundamental technical improvement to how machines can process, compare, and relate disparate educational data types.

Similarly, the use of a pretrained autoencoder in the submission analysis unit provides a technical mechanism for abstracting key features from user-generated responses, even when those responses vary in wording, notation, or format. The autoencoder compresses and encodes the solution and submission into latent vector space, allowing the system to isolate and quantify the conceptual distance between them. This enables the determination of which curriculum concepts were applied or omitted-capabilities not feasible in prior systems that lacked such latent-space analysis.

The embedding and autoencoder models are trained or fine-tuned using educational corpora including textbook-derived questions, solution explanations, and aligned curricular concepts, making the models domain-adapted rather than generic.

Describing with FIG. 8b as an example, if it is assumed that the first question embedding vector EV_QD1 is included in the concept embedding vector EV_CI and the first solution embedding vector EV_AD1 is included in the concept embedding vector EV_CI, the first comparison unit 221b can determine concepts such as “a perpendicular and similarity of figures,” which are concepts corresponding to the first question embedding vector EV_QD1 and the first solution embedding vector EV_AD1, as the requirement information RI.

Referring again to FIGS. 2 and 7, the submission analysis unit 222 may determine deficiency information (hereinafter referred to as “DI”) based on the solution data AD, the submission data SD, and the requirement information RI.

As some examples, the submission analysis unit 222 may determine at least one concept included in the requirement information RI as the deficiency information DI by comparing the solution data AD with the submission data SD. For example, the submission analysis unit 222 may determine at least one concept of the plurality of concepts (e.g., C_1 in FIG. 5) included in the requirement information RI and the sub-concepts included therein as the deficiency information DI based on the comparison result of the solution data AD with the submission data SD.

In this case, the submission analysis unit 222 may determine the deficiency information DI by using an auto-encoder.

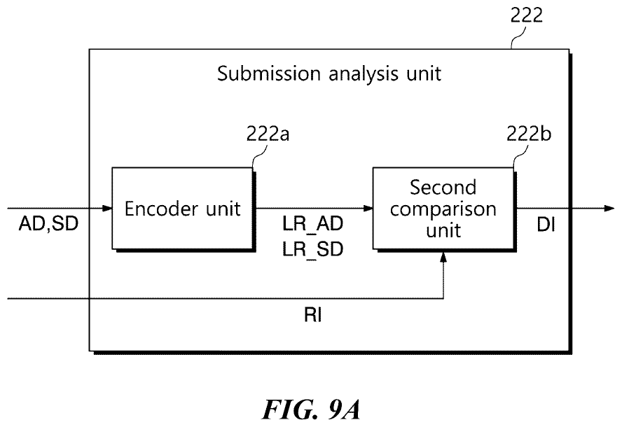

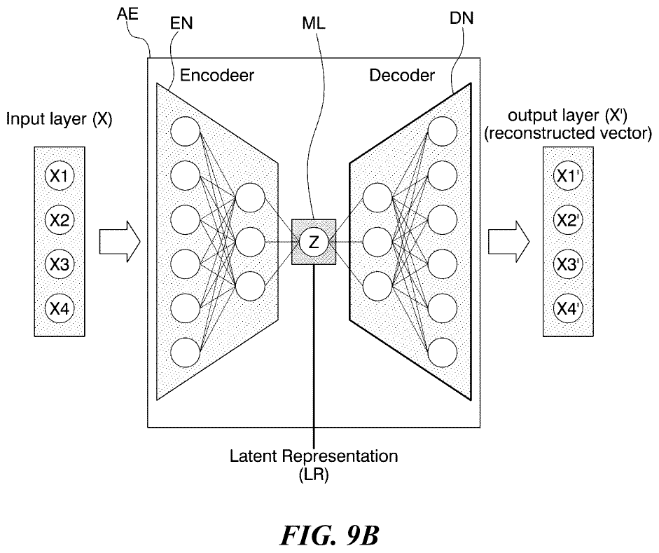

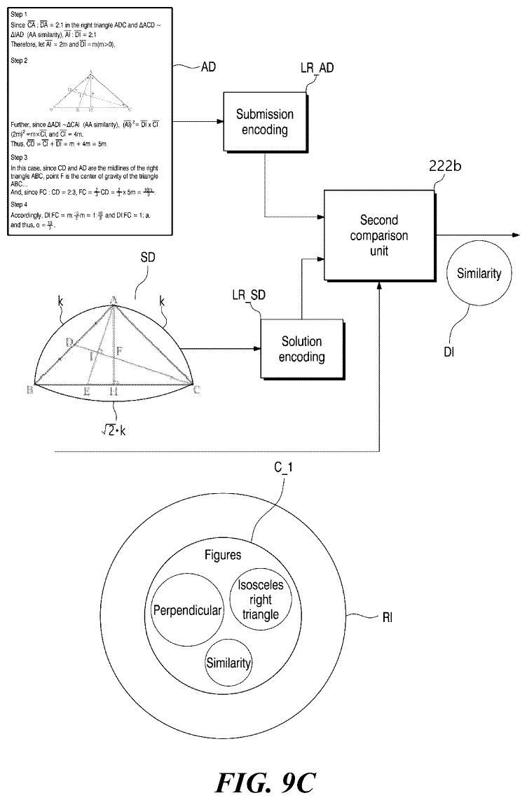

In the following, the submission analysis unit 222 according to some embodiments of the present disclosure will be described in greater detail with reference to FIGS. 9a to 9c.

FIG. 9a is a detailed block diagram of the submission analysis unit included in the analysis module according to some embodiments of the present disclosure. FIG. 9b is a diagram for describing an auto-encoder according to some embodiments of the present disclosure. FIG. 9c is a diagram for describing the operation of the submission analysis unit according to some embodiments of the present disclosure.

Referring to FIGS. 2, 7, and 9a to 9c, the submission analysis unit 222 may include an encoder unit 222a that converts each of the solution data AD and the submission data SD into a latent representation (hereinafter referred to as “LR”), and a second comparison unit 222b that defines the deficiency information DI based on the encoding result.

The encoder unit 222a may generate a solution encoding LR_AD and a submission encoding LR_SD by encoding each of the solution data AD and the submission data SD in the form of a latent representation LR. As some examples, the encoder unit 222a may compress the solution data AD and the submission data SD in the manner of extracting main features from each of the solution data AD and the submission data SD, and determine the compressed results as the solution encoding LR_AD and the submission encoding LR_SD.

In this case, the solution encoding LR_AD and the submission encoding LR_SD may be in the form of a set of a plurality of vectors.

This encoder unit 222a may include the structure of an encoder EN in an auto-encoder (hereinafter referred to as “AE”) as shown in FIG. 9b.

The auto-encoder AE may include an encoder network (hereinafter, encoder EN) and a decoder network (hereinafter, decoder DN), and may include a middle layer ML arranged between the encoder EN and the decoder DN. The auto-encoder AE is a kind of deep neural network model that reduces data by compressing the data (i.e., input data) received via the encoder EN and then converts and outputs the reduced data into the same size as the input data at the encoder EN by using the decoder DN, thereby making the output data of the auto-encoder AE the same as the input data. The auto-encoder AE learns the features of the input data in an unsupervised manner. To this end, the auto-encoder AE may convert the data received via the encoder EN into lower-dimensional data (latent representation LR) that represents the corresponding features well, and the converted data may then be reconstructed to the original data via the decoder DN. The auto-encoder AE may learn patterns inherently present in the original data with the goal of minimizing the reconstruction error corresponding to the difference between the original data X1, X2, X3, and X4 (i.e., the input data (satellite data)) and the reconstructed data X1′, X2′, X3′, and X4′ (i.e., the output data (index)).

Further, the encoder unit 222a according to some embodiments of the present disclosure including such an encoder EN structure may be trained by the training module 230 to compress and encode the solution data AD and the submission data SD when they are input and to output the solution encoding LR_AD and the submission encoding LR_SD.

In this way, by using the solution encoding LR_AD and the submission encoding LR_SD generated by the encoder unit 222a rather than using the solution data AD and the submission data SD as they are, the accuracy of comparison of the solution data AD with the submission data SD can be improved significantly. That is, in the case of submission data SD generated by a touch input to a user terminal (102 in FIG. 1) or the like, there may occur a difference in format from the solution data AD depending on the user's handwriting, description style, the sequence of solving the question, and the like even after going through a correct solving process, which could be an obstacle to accurately identifying what concepts the corresponding user lacks. Therefore, it may be difficult to accurately generate the deficiency information DI for the user if the solution data AD and the submission data SD themselves are compared as they are, but the present disclosure has a novel effect of being able to prevent instances where the deficiency information DI is determined inaccurately due to the difference in format between the solution data AD and the submission data SD by extracting the main features of the submission data SD by compressing and encoding the submission data SD and by determining the deficiency information DI based thereon.

The second comparison unit 222b may determine the deficiency information DI based on the solution encoding LR_AD, the submission encoding LR_SD, and the requirement information RI.

As some examples, the second comparison unit 222b may determine missing vectors that are included in the solution encoding LR_AD but not in the submission encoding LR_SD by comparing the solution encoding LR_AD with the submission encoding LR_SD, and may determine concepts corresponding to the determined missing vectors out of the plurality of concepts included in the requirement information RI as the deficiency information DI.

Describing with FIG. 9c as an example, it can be seen through the submission data SD that the user has set the length of one side of the triangle to “k” and has set the length of the hypotenuse to “√2k” according to the property of an isosceles right triangle in the process of deriving the answer, as described above in FIG. 4. However, the submission data SD does not include a symbolic representation or text description of the point that the “triangle ACD” and the “triangle IAD” are similar in the figure. Accordingly, the submission encoding LR_SD may include a feature vector related to an isosceles right triangle, but may not include a feature vector related to the similarity of figures. In this case, the second comparison unit 222b may determine the feature vector related to the similarity of figures as a missing vector that is included in the solution encoding LR_AD but not in the submission encoding LR_SD, and may determine the concept of “similarity” corresponding to the determined missing vector out of the plurality of concepts included in the requirement information RI (e.g., “perpendicular, isosceles right triangle, similarity” included in C_1) as the deficiency information DI.

Referring again to FIGS. 2 and 7, the determination unit 223 may determine at least one of the requirement information RI and the deficiency information DI as the analysis data AAD.

In other words, the determination unit 223 may determine one or both of the requirement information RI generated by the question analysis unit 221 and the deficiency information DI generated by the submission analysis unit 222 as the analysis data AAD.

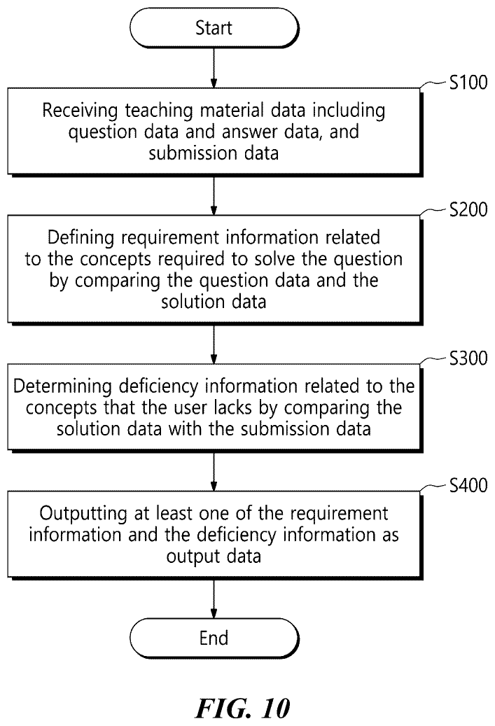

FIG. 10 is a flowchart of a teaching material analysis method according to some embodiments of the present disclosure. Each step (S100 to S400) of FIG. 10 may be performed by the teaching material analysis device 200 of FIGS. 1 and 2. In the following, descriptions will be made briefly with the overlapping parts excluded.

Referring to FIGS. 1, 2, 7, and 10, first, the teaching material analysis device 200 may receive teaching material data DD including question data QD and solution data AD, and submission data SD (S100).

The teaching material data DD may refer to data on questions and solutions present in a teaching material.

The question data QD may refer to data on each of a plurality of questions included in a teaching material. In this case, the question data QD may include text data, image data, and the like, as shown in FIG. 3, but the embodiment of the present disclosure is not limited thereto.

The solution data AD may be data on the answer to each of the plurality of questions included in the teaching material. In this case, the solution data AD may include information on the answer to a corresponding question, the processes for deriving the answer, and the like. In this case, the solution data AD may include text data, image data, and the like, as shown in FIG. 3, but the embodiment of the present disclosure is not limited thereto.

The submission data SD is data on the user's response to the corresponding question, the process of solving the question, the result of solving the question, and the like. As some examples, the user terminal 102 may output the question data QD received via the teaching material database 101 onto a screen, receive the user's touch input, keyboard input, or the like in response thereto, and then generate the submission data SD of the user based on the received data.

At this time, the teaching material analysis device 200 may further receive concept information CI including a plurality of concepts contained in textbooks, curricula, etc. In this case, the concept information CI may include a plurality of concepts distinguished by predefined types. As one example, the concept information may include a concept set containing a plurality of predefined concepts and/or a concept tree in which a plurality of concepts is ordered according to a predefined learning sequence and concept difficulty.

Next, the teaching material analysis device 200 may define requirement information RI related to the concepts required to solve the question by comparing the question data QD and the solution data AD (S200).

As some examples, the teaching material analysis device 200 may determine at least one concept included in the concept information CI as the requirement information RI by comparing the question data QD with the solution data AD. For example, the teaching material analysis device 200 may determine at least one concept of a plurality of concepts (e.g., C_1 to C_5 in FIG. 5) included in the concept information CI and sub-concepts included therein as the requirement information RI based on the comparison result of the question data QD with the solution data AD. A detailed description thereof will be omitted.

Next, the teaching material analysis device 200 may determine deficiency information DI related to the concepts that the user lacks by comparing the solution data AD with the submission data SD (S300).

As some examples, the teaching material analysis device 200 may determine at least one concept included in the requirement information RI as the deficiency information DI by comparing the solution data AD with the submission data SD. For example, the teaching material analysis device 200 may determine at least one concept of the plurality of concepts (e.g., C_1 in FIG. 5) included in the requirement information RI and the sub-concepts included therein as the deficiency information DI based on the comparison result of the solution data AD with the submission data SD. In this case, the teaching material analysis device 200 may determine the deficiency information DI by using an auto-encoder.

Next, the teaching material analysis device 200 may output at least one of the requirement information RI and the deficiency information DI as output data (S400).

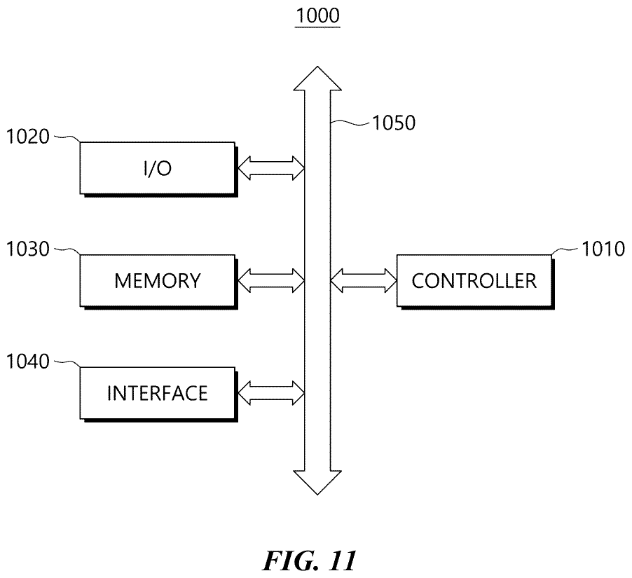

FIG. 11 is a diagram for describing a hardware implementation of a teaching material analysis device that performs a teaching material analysis method according to some embodiments of the present disclosure.

Referring to FIGS. 1 and 11, the teaching material analysis device 200 according to some embodiments of the present disclosure may be implemented in an electronic device 1000. The electronic device 1000 may include a controller 1010, an input/output device I/O 1020, a memory device 1030, an interface 1040, and a bus 1050. The controller 1010, the input/output device 1020, the memory device 1030, and/or the interface 1040 may be coupled to each other via the bus 1050. In this case, the bus 1050 corresponds to a path through which data is moved.

Specifically, the controller 1010 may include at least one of a central processing unit (CPU), a microprocessor unit (MPU), a microcontroller unit (MCU), a graphic processing unit (GPU), a microprocessor, a digital signal processor, a microcontroller, an application processor (AP), and logic devices capable of performing functions similar thereto.

The input/output device 1020 may include at least one of a keypad, a keyboard, a touch screen, and a display device.

The memory device 1030 may store data and/or a program, etc.

The interface 1040 may perform the function of transmitting data to a communication network or receiving data from the communication network. The interface 1040 may be of a wired or wireless form. For example, the interface 1040 may include an antenna, a wired/wireless transceiver, or the like. Although not shown, the memory device 1030 may be an operating memory for improving the operation of the controller 1010, which may further include a high-speed DRAM and/or SRAM, etc. The memory device 1030 may store a program or an application therein.

The teaching material analysis device 200 according to the embodiments of the present disclosure may be a system formed by connecting a plurality of electronic devices 1000 to each other via a network. In such a case, each module or combinations of modules may be implemented in the electronic device 1000. However, the present embodiment is not limited thereto.

Additionally, the teaching material analysis device 200 may be implemented in at least one of a workstation, a data center, an Internet data center (IDC), a direct-attached storage (DAS) system, a storage area network (SAN) system, a network-attached storage (NAS) system, a redundant array of inexpensive disks or redundant array of independent disks (RAID) system, and an electronic document management system (EDMS), but the present embodiment is not limited thereto.

Furthermore, the teaching material analysis device 200 may transmit data to the external database 100 via a network. The network may include a network based on wired Internet technology, wireless Internet technology, and short-range communication technology. The wired Internet technology may include, for example, at least one of a local area network (LAN) and a wide area network (WAN).

The wireless Internet technology may include, for example, at least one of wireless LAN (WLAN), Digital Living Network Alliance (DMNA), Wireless Broadband (WiBro), World Interoperability for Microwave Access (WiMAX), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), and 5G New Radio (NR) technology. However, the present embodiment is not limited thereto.

The short-range communication technology may include, for example, at least one of Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, Wi-Fi Direct, and 5G New Radio (NR). However, the present embodiment is not limited thereto.

The teaching material analysis device 200 communicating over a network may comply with technical standards and standard communication methods for mobile communication. For example, the standard communication methods may include at least one of Global System for Mobile communication (GSM), Code Division Multiple Access (CDMA), Code Division Multiple Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), and 5G New Radio (NR). However, the present embodiment is not limited thereto.

The disclosed system improves the functioning of a computing device by enabling it to interpret semantically rich, context-sensitive educational input-capabilities not possible using conventional keyword or rules-based systems. This reduces reliance on manual tagging, increases concept-matching accuracy, and enables real-time feedback generation, all of which reflect concrete improvements to data processing techniques.

The disclosed system provides several technical improvements in the field of automated educational analysis. It enables computing systems to semantically compare student-written responses with structured model solutions by encoding them into latent vector space representations. This capability allows the system to identify conceptual similarities and omissions with significantly greater precision than traditional rule-based or keyword-matching approaches. The system also facilitates fine-grained mapping of learner responses to predefined curricular concepts by analyzing overlaps and deficiencies within these vector representations. By applying pretrained deep learning models to unstructured educational data—including questions, answers, and student submissions—the system leverages domain-specific training to enhance accuracy and contextual relevance. As a result, the system improves both the speed and reliability of educational feedback generation, enabling scalable, real-time diagnostic assessment that reflects true learner understanding. These capabilities represent concrete enhancements to data processing and computer functionality, extending beyond abstract educational theory and firmly situating the disclosure within the realm of technological advancement.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A teaching material analysis device comprising:
a data collection module configured to receive teaching material data including question data related to a predefined question and solution data related to an answer to the question, and submission data related to problem-solving of a user for the question;
an analysis module configured to generate analysis data for at least one of the question data and the submission data based on the teaching material data and the submission data; and
an output module configured to output the analysis data as output data,
wherein the analysis module comprises:
a question analysis unit configured to define requirement information related to concepts required to solve the question by comparing the question data with the solution data;
a submission analysis unit configured to determine some of the generated requirement information as deficiency information related to concepts the user lacks by comparing the solution data with the submission data; and
a determination unit configured to determine at least one of the requirement information and the deficiency information as the analysis data.

2. The teaching material analysis device of claim 1, wherein the data collection module further receives concept information comprising a concept set and a concept tree, which are predefined, from a curriculum database that is present externally.

3. The teaching material analysis device of claim 2, wherein the question analysis unit determines at least one concept included in the concept information as the requirement information by comparing the question data with the solution data.

4. The teaching material analysis device of claim 3, wherein the question analysis unit comprises:
an embedding unit configured to generate a question embedding vector, a solution embedding vector, and a concept embedding vector by converting the question data, the solution data, and the concept information into embedding vectors; and
a first comparison unit configured to define the requirement information based on the question embedding vector, the solution embedding vector, and the concept embedding vector.

5. The teaching material analysis device of claim 4, wherein the embedding unit generates the question embedding vector, the solution embedding vector, and the concept embedding vector by using a pre-trained embedding vector conversion algorithm.

6. The teaching material analysis device of claim 4, wherein the first comparison unit:
determines an overlapping vector that overlaps with the question embedding vector and the solution embedding vector out of the concept embedding vector, and
determines a concept corresponding to the overlapping vector out of the plurality of concepts as the requirement information.

7. The teaching material analysis device of claim 1, wherein the submission analysis unit generates the deficiency information by comparing the solution data with the submission data using a pre-trained auto-encoder.

8. The teaching material analysis device of claim 7, wherein the submission analysis unit includes:
an encoder unit configured to generate a solution encoding and a submission encoding by encoding each of the solution data and the submission data in the form of a latent representation; and
a second comparison unit configured to determine the deficiency information based on the solution encoding and the submission encoding.

9. The teaching material analysis device of claim 8, wherein the second comparison unit:
determines a missing vector that is included in the solution encoding but not in the submission encoding by comparing the solution encoding with the submission encoding, and
determines a concept corresponding to the determined missing vector out of a plurality of concepts included in the requirement information as the deficiency information.

10. The teaching material analysis device of claim 1, further comprising:
a training module configured to train an embedding unit and a first comparison unit included in the question analysis unit, and an encoder unit and a second comparison unit included in the submission analysis unit.

11. The teaching material analysis device of claim 10, wherein the training module is configured to train the embedding unit and the encoder unit using educational training data comprising labeled question-concept pairs and student submissions mapped to predefined curricular concepts.

12. The teaching material analysis device of claim 10, wherein the training module is configured to train the embedding unit and the encoder unit using educational training data comprising labeled question-concept pairs and student submissions mapped to predefined curricular concepts.

13. The teaching material analysis device of claim 2, wherein the concept tree comprises nodes hierarchically arranged based on concept difficulty or prerequisite relationships, and the analysis module dynamically selects a learning path based on identified deficiency information.

14. The teaching material analysis device of claim 9, wherein the second comparison unit determines the missing vector based on a distance metric exceeding a threshold in a latent vector space.

15. The teaching material analysis device of claim 1, wherein the question data, solution data, and submission data comprise at least one of textual, handwritten, or image-based data, and the analysis module is configured to normalize and process multimodal input.
